(19) United States
(12) Patent Application Publication
(10) Pub. No.: US 2009/0095711 A1
(43) Pub. Date: Apr. 16, 2009

(54) MICROFABRICATION APPARATUS AND DEVICE MANUFACTURING METHOD

(76) Inventors: Takeshi Koshiba, Yokohama-shi (JP); Yumi Nakajima, Tokyo (JP); Tetsuro Nakasugi, Yokohama-shi (JP); Kazuo Tawarayama, Tsukuba-shi (JP); Ikuo Yoneda, Yokohama-shi (JP); Hiroyuki Mizuno, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/237,806

(22) Filed: Sep. 25, 2008

(30) Foreign Application Priority Data
Sep. 28, 2007 (JP) 2007-256233

(51) Int. Cl. B44C 1/22; B29C 43/02

(52) U.S. Cl. 216/52; 425/150

(57) ABSTRACT

A microfabrication apparatus for pressing an original plate including a pattern down on a substrate to transfer the pattern on the substrate includes a first measurement unit for measuring relative positional displacement between the substrate and the plate above the substrate, a position correction unit for correcting relative position between the substrate and the plate such that the pattern is to be transferred on a first predetermined position of the substrate based on the relative positional displacement measured by the first measurement unit, a pressing unit for pressing the plate above the substrate down on the substrate to transfer the pattern on the substrate in a state that the relative positional displacement between the substrate and the plate is corrected by the position correction unit, and a second measurement unit for measuring relative positional relationship between the pattern transferred on the substrate and a pattern previously formed on the substrate.

### CROSS-REFERENCE TO RELATED APPLICATIONS

This application is based upon and claims the benefit of priority from prior Japanese Patent Application No. 2007-256233, filed Sep. 28, 2007, the entire contents of which are incorporated herein by reference.

### BACKGROUND OF THE INVENTION

1. Field of the Invention

The present invention relates to a microfabrication apparatus and a device manufacturing method using nanoimprint technique used for manufacturing a device such as a semiconductor device, an optical device, or a bio-product.

2. Description of the Related Art

As a technique to manage both the formation of fine patterns of less than 100 nm and the mass-productivity in the manufacture of semiconductor devices, nanoimprint technique has received attention by which a pattern of original plate (mold, template) is transferred on an object substrate.

One such nanoimprint technique is optical (UV) nanoimprint. The optical imprint technique includes a step of applying light curing resin on a substrate, a step of aligning an original plate with the substrate, a step of directly pressing the original plate down on the light curing resin, a step of irradiating the light curing resin with light to cure it, a step of releasing the original plate from the light curing resin, a step of rinsing the substrate and the light curing resin, and a step of removing unnecessary light curing resin (remnant film) on the substrate.

As a method for aligning the original plate with the substrate, the method illustrated in FIG. 13 (JP-A 2000-323461 (KOKAI)) is know. In FIG. 13, 100 denotes a wafer, an alignment mark 101 is formed on a surface of the wafer 100. A layer 102 is formed the wafer 100 such that the alignment mark 101 is covered with the layer 102. An original plate 103 is disposed above the wafer 100 with a certain distance therebetween. Alignment mark 104 is formed on a surface of the original plate 103 wherein the surface is opposed to the wafer 100. By using a laser source (not shown), a laser beam 105 is irradiated on the alignment marks 101 and 104, and the reflected light 108 is detected by photosensors 107 to observe changing of the intensity of reflected light 106, thereby positional confirmation of the marks is performed.

In the process of manufacturing semiconductor device, misalignment between the transferred pattern and a pattern formed on the underlying layer is inspected. If the misalignment amount is within an acceptable value, the manufacturing process goes to the next step. If the misalignment amount is out of the acceptable value, it is a common to repeat the transferring process after removing the resist layer on which the transferred pattern is formed. If the misalignment amount is out of the acceptable value, the measured misalignment amount is fed back to the transferring process to ensure high position accuracy.

### BRIEF SUMMARY OF THE INVENTION

According to an aspect of the present invention, there is provided a microfabrication apparatus configured to press an original plate including a pattern down on an object substrate to transfer the pattern on the object substrate, the microfabrication apparatus comprising: a first measurement unit configured to measure relative positional displacement between the object substrate and the original plate disposed above the object substrate; a position correction unit configured to correct relative position between the object substrate and the original plate such that the pattern is to be transfer on a first predetermined position of the object substrate based on the relative positional displacement measured by the first measurement unit; a pressing unit configured to press the original plate disposed above the object substrate down on the object substrate to transfer the pattern on the object substrate in a state that the relative positional displacement between the object substrate and the original plate is corrected by the position correction unit; and a second measurement unit configured to measure relative positional relationship between the pattern transferred on the object substrate and a pattern previously formed on the object substrate.

### BRIEF DESCRIPTION OF THE SEVERAL VIEWS OF THE DRAWING

FIG. 1 is a schematic diagram of a microfabrication apparatus of a first embodiment;

FIG. 2 is a flowchart illustrating a microfabrication method of the first embodiment;

FIGS. 3A and 3B illustrating an example of misalignment inspection marks;

FIG. 4 is a diagram for explaining a method of feeding back the result of misalignment inspection to the subsequent original plate pressing process when the misalignment inspection is carried out immediately after initial original plate pressing process;

FIG. 5 is a diagram illustrating a situation in which the pattern transferred position is shifted by ΔL as the result of misalignment inspection after the all patterns are transferred;

FIG. 6 is a schematic diagram of a microfabrication apparatus of a second embodiment;

FIG. 7 is a schematic diagram of a microfabrication apparatus of a third embodiment;

FIG. 8 is a flowchart illustrating a microfabrication method of the third embodiment;

FIG. 9 is a flowchart illustrating a microfabrication method of a fourth embodiment;

FIG. 10 is a flowchart illustrating a microfabrication method of a fifth embodiment;

FIG. 11 shows random error versus number of sampling points;

FIG. 12 is a flowchart illustrating a microfabrication method of a sixth embodiment; and

FIG. 13 is a diagram for explaining a conventional method of aligning an original plate with an object substrate.

### DETAILED DESCRIPTION OF THE INVENTION

As mentioned above, in the process of manufacturing semiconductor device, misalignment between the transferred pattern and the pattern formed on the underlying layer is inspected. In order to carry out such the misalignment inspection, it is required to take the wafer (object substrate) out of the nanoimprint apparatus after the transferring process and carry it in an alignment inspection apparatus. Such the movement of wafer between those apparatuses results in reduced throughput of device fabrication. Hereinafter, the embodiments that suppress such the lowering of throughput will be described with reference to the accompanying drawings.

### First Embodiment

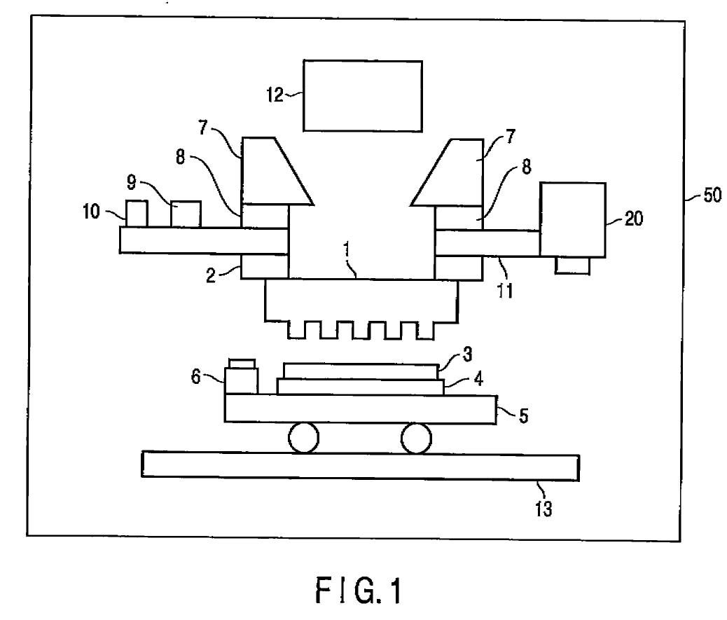

FIG. 1 schematically shows a microfabrication apparatus according to a first embodiment. The microfabrication apparatus of the present embodiment comprises a nanoimprint apparatus.

In FIG. 1, an original plate (a mold, a template) 1 including a pattern (transfer pattern) formed of a plurality of projections and depressions is held on an original plate stage 2. Here, the material of original plate 1 is such as quartz or fluorite, which allows ultraviolet rays to pass through. The transfer pattern includes a pattern corresponding to a device pattern and a pattern corresponding to an alignment inspection mark used at the time of misalignment inspection. The original plate stage 2 can be moved so that the original plate 1 is positioned at the apparatus reference position.

An object substrate 3 on which the transfer pattern is to be transferred is held on a chuck 4. The object substrate 3 includes a substrate such as a semiconductor substrate, an underlying pattern formed on the substrate, and a layer to be processed formed on the underlying pattern. At the time of transferring pattern (nanoimprinting), the substrate further includes light curing resin formed on the layer to be processed. The layer to be processed is an insulating layer, a metal layer (conducting layer), or a semiconductor layer.

By using the microfabrication apparatus of the embodiment, a substrate with the light curing resin on which the transfer pattern is transferred (nanoimprinted) is formed. In addition, the light curing resin having the transfer pattern transferred is developed to obtain a pattern (resist pattern), the layer to be processed is etched by using the resist pattern as a mask to transfer the transfer pattern to the layer, thereby the object substrate is formed.

The chuck 4 is configured to be fixed on a sample stage 5. It is desirable that the sample stage 5 can be moved along three mutually orthogonal axes X, Y and Z and rotated about each of the three axes. The sample stage 5 is placed on a stage bench 13.

A reference mark stand 6 is fixed on the sample stage 5. A reference mark (not shown) serving as the reference position of apparatus is placed on the reference mark stand 6. The reference mark is comprised of a diffraction grating. The reference mark is used for calibrating the alignment sensors and positioning the original plate 1 (attitude control and adjustment).

A first alignment mark (original plate alignment mark) not shown is formed on the original plate 1. A second alignment mark (underlying alignment mark) is formed on an underlying pattern which is previously formed on the object substrate 3. The underlying alignment mark and the original plate alignment marks are used to measure a relative positional displacement between the original plate 1 and the object substrate 3. Here, the original plate alignment marks and the underlying alignment mark comprise diffraction gratings respectively.

A positional displacement of the original plate 1 with respect to the reference mark and a positional displacement of the object substrate 3 with respect to the original plate are measured by the alignment sensors 7 (first measurement unit). The alignment sensors 7 are fixed on the alignment stage 8.

The positional displacement of the original plate 1 with respect to the reference mark is detected by moving the sample stage 5 using a moving mechanism not shown to a location where the reference mark and the original plate 1 can be detected simultaneously then irradiating the reference mark and the original plate alignment mark with light from a light source not shown and measuring the position of center of gravity of light diffracted and reflected back to the alignment sensors 7.

On the other hand, a positional displacement of the object substrate 3 with respect to the original plate 1 (the relative positional displacement between the original plate and the substrate) is obtained by moving the sample stage 5 using the moving mechanism not shown to a location where the opposed original plate alignment mark and the underlying alignment mark can be detected simultaneously, then irradiating light from the light source onto the original plate alignment mark and the underlying alignment mark and measuring the position of center of gravity of light diffracted and reflected back to the alignment sensors 7.

A correction mechanism 9 (correction unit) has an adjustment mechanism for fine adjustment of the position (attitude) of the original plate 1. The adjustment mechanism corrects the relative position between the original plate 1 and the object substrate 3 by fine adjustment of the position of the original plate 1.

When the pattern of the original plate 1 is transferred (nanoimprinted) on the object substrate 3, the original plate 1 disposed above the object substrate 3 is pressed down on the object substrate 3 by means of a pressure application unit 10 (pressing unit) in a state that the relative position between the original plate 1 and the object substrate 3 is corrected by the correction mechanism 9. Thereby, the pattern transferring with high accuracy is made to be possible.

In spite of the fact that only two alignment sensors 7 (right and left ones) are shown in FIG. 1, it is preferable that the number of the alignment sensors is four or more.

A UV light source 12 is fixed on the base body (not shown). Ultraviolet rays emitted from the UV light source 12 are irradiated onto the light curing resin applied on the transfer area of the object substrate 3 through the original plate 1. In spite of the fact that the UV light source 12 is disposed just above the original plate 1 in FIG. 1, the disposition of the UV light source 12 is not limited to the above mentioned place.

The microfabrication apparatus of the present embodiment further comprises a misalignment inspection mechanism 20 (second measuring unit). The misalignment inspection mechanism 20 is attached to a base 11 of the apparatus. Here, the misalignment inspection mechanism 20 is an overlay inspection apparatus. The misalignment inspection mechanism 20 is adapted to measure a relative positional displacement between the alignment inspection mark previously formed on the underlying pattern of the object substrate 3 and the alignment inspection mark of the original plate 1 transferred onto the light curing resin applied on the object substrate 3. The misalignment inspection mechanism 20 is made of a conventional optical inspection one by way of example.

The original plate 1, the original plate stage 2, the chuck 4, sample stage 5, reference mark stand 6, alignment sensors 7, the alignment stage 8, the correction mechanism 9, the pressure application unit 10, the base 11, the UV light source 12, the stage bench 13, and the misalignment inspection mechanism 20 are provided in a chamber 100. That is, the microfabrication apparatus of the present embodiment is configured to measure the misalignment of the object substrate 3 (wafer) in the chamber 100 without taking the object substrate 3 out of the chamber 100 after the transferring process (nanoimprint process) is performed.

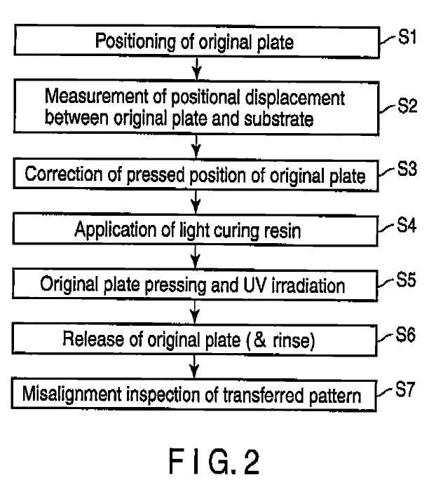

Next, the microfabrication method of the present embodiment (pattern transferring method and misalignment inspection method after the pattern transferring) will be described with reference to a flowchart of FIG. 2.

[Step S1]

The sample stage 5 is moved to the position where the original plate alignment mark of the original plate 1 and the reference mark of the reference mark stand 6 are opposed to each other. The positional displacement between the original plate alignment mark and the reference mark (a positional displacement between the original plate 1 and the reference mark stand 6) is measured by the alignment sensors 7. On the basis of the measured positional displacement, the original plate stage 2 is moved by the original plate movement mechanism not shown to position the original plate at the apparatus reference position, In subsequent steps, the position of the original plate 1 (original plate alignment mark) serves as the apparatus reference position.

[Step S2]

The relative positional displacement between the alignment mark and the original plate alignment mark which are opposed to each other (relative positional displacement between the object substrate 3 and the original plate 1 disposed above the substrate) is measured by the alignment sensors 7. This alignment measurement is made for each of shot position where the pattern is transferred (die-by-die alignment method).

### [Step S3]

Based on the measured positional displacement, the position (attitude) of the original plate 1 is finely adjusted (corrected) by the correction mechanism 9 to correct the relative position between the original plate 1 and the object substrate 3 (press position of original plate 1) so that the pattern of the original plate 1 is transferred on the predetermined position on the object substrate 3.

In general, there are a plurality of pairs of the original plate alignment mark and the underlying alignment mark opposing each other. Therefore, the positional displacement is measured for each pair by the alignment sensors 7 (step S2), and the press position of the original plate 1 is corrected on the basis of the results of the misalignment measurements (step S3).

Here, the position (attitude) of the original plate 1 is finely adjusted (corrected) by the correction mechanism 9 provided on the original plate stage 2 to correct the press position of the original plate 1, alternatively, the sample stage 5 may be equipped with a correction mechanism to adjust the position of the sample stage 5 so that the press position of original plate 1 is corrected. Furthermore, each of the original plate stage 2 and the sample stage 5 may be equipped with a correction mechanism, in which case the position of each of them is adjusted individually by the corresponding correction mechanism to correct the press position of the original plate 1.

[Step S4]

After the press position of the original plate 1 is corrected, the light curing resin is applied only on the area of the object substrate 3 where the original plate 1 is to be pressed.

[Step S5]

In the state that the press position of the original plate 1 is corrected by the correction mechanism 9, the original plate 1 is pressed down on the light curing resin by means of the pressure application unit 10. Ultraviolet rays are emitted from the UV light source 12 to cure (harden) the light curing resin.

[Step S6]

The original plate 1 is released from the hardened light curing resin. After that, if necessary, the original plate 1 is washed (rinsed). The light curing resin has the device pattern and the alignment mark (misalignment inspection mark) transferred on it. Thus, a transfer of one pattern is completed.

Here, in order to make it easy to release the original plate 1 from the hardened light curing resin, it is useful to previously coat the original plate 1 with an original plate release agent.

[Step S7]

Steps S2 to S6 are repeated to transfer a desired number of patterns. After that, the transferred patterns are inspected for misalignment. The misalignment inspection is made using the misalignment inspection mechanism 20. Therefore, the sample stage 5 is moved so that the alignment inspection marks are positioned directly below the misalignment inspection mechanism 20.

In the case of a standard semiconductor device manufacturing process, the misalignment inspection is carried out in alignment inspection apparatus into which the substrate is carried after all the patterns are transferred onto the light curing resin on the substrate in exposure apparatus and the light curing resin is developed outside the exposure apparatus using an alkali developing solution. The alignment inspection apparatus carries out alignment inspection by measuring the relative positional relationship between the transferred pattern formed by the development and the alignment inspection marks previously formed on the substrate using an optical inspection apparatus. Thus, the alignment inspection involves a step of moving the substrate from the exposure apparatus to the inspection apparatus, which reduces throughput of device manufacturing.

However, in the present embodiment, the utilization of both the device pattern and the alignment inspection mark transferred onto the light curing resin allows inspection of misalignment by the misalignment inspection mechanism 20 in the microfabrication apparatus. Thus, the present embodiment can carry out the pattern transfers and the alignment inspection in the same apparatus, which suppresses lowering of throughput of device manufacturing.

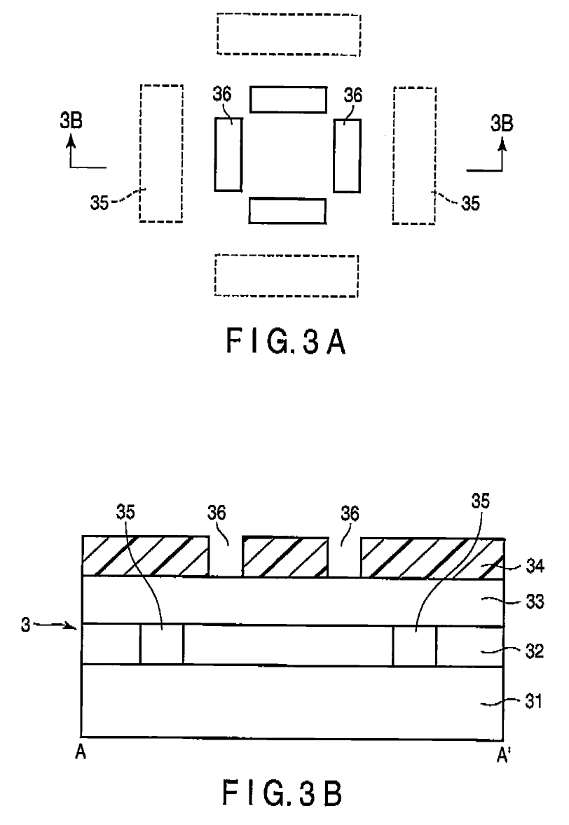

FIGS. 3A and 3B show an example of misalignment inspection mark.

As shown in FIG. 3B, a substrate 31, such as a semiconductor substrate, is formed on top with a lower layer 32 having a device pattern not shown. The lower layer 32 is formed on top with a layer 33 to be processed. The layer 33 is formed on top with a pattern (resist pattern) 34 made of light curing resin wherein the pattern is transferred by the original plate 1. The lower layer 32 is formed with alignment inspection marks (outer marks) 35. The resist pattern 34 is formed with alignment inspection marks (inner marks) 36.

As shown in FIG. 3A, the alignment inspection marks 35 and 36 forms a bar-in-bar mark. The alignment inspection marks 35 are used to detect the position of the underlying pattern previously formed on the substrate 31. The alignment inspection marks 36 are used to detect the position of the pattern (resist pattern) transferred onto the light curing resin on the substrate 31. The difference in the center of gravity between the alignment inspection marks 35 and 36 is detected by the misalignment inspection mechanism 20.

In FIGS. 3A and 3B, there is illustrated one bar-in-bar mark for simplicity. In practice, alignment inspection is made for a plurality of bar-in-bar marks set up in advance.

In the present embodiment, the bar-in-bar mark is used, however, other alignment marks such as box-in-box mark may be used, or the alignment mark may be served as the alignment inspection mark.

When the alignment inspection is made immediately after the initial original plate pressing process, the results of alignment inspection (misalignment errors) can be fed back to subsequent original plate pressing processes.

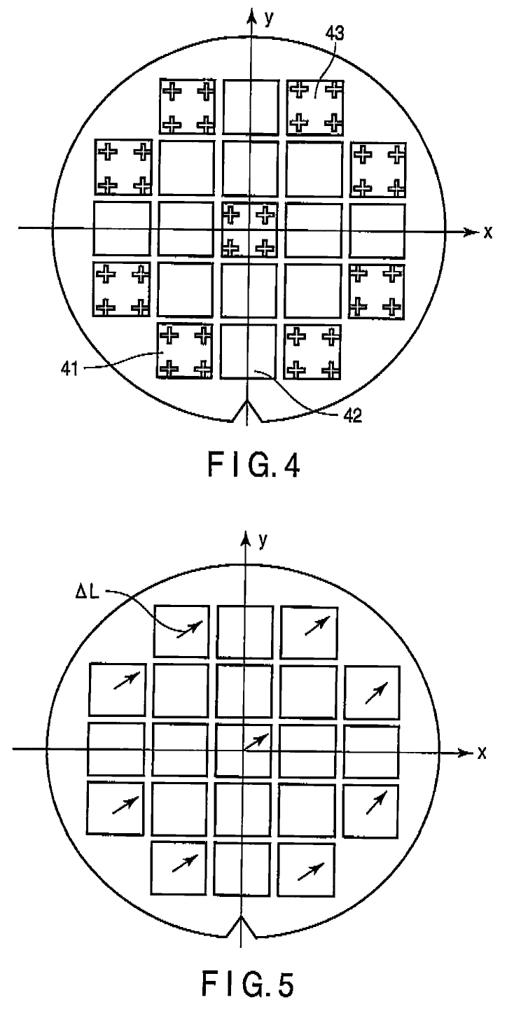

For example, when the initial original plate pressing process (step S6) is carried out on a chip 41 of FIG. 4 after steps S1 to S5, only the chip 41 is inspected for alignment after the pattern transferring. Alignment errors obtained by the alignment inspection are fed back to the correction mechanism 9 to correct original plate pressing positions for other chips. Thereby, the original plate 1 pressing positions can be determined with high accuracy. In addition, since alignment inspection can be performed without making pattern transfers over the entire surface of a wafer (substrate), the throughput can be improved. In FIG. 4, cross-shaped marks indicate alignment marks (underlying alignment mark) formed on the wafer (substrate).

In addition, throughput will be further improved by using a global alignment method in step S1 and S2 of FIG. 2, which involves detecting predetermined alignment marks on the substrate, calculating the average correction value for all the original plate pressing positions on the substrate based on the result of the detecting, and correcting the original plate pressing positions by the correction mechanism 8 based on the calculated average position correction value.

For example, at first, all positions of the cross marks (alignment marks) shown in FIG. 4 is detected, the average position correction value for all the original plate pressing positions on the wafer (substrate) is calculated based on the results of the detection, the position (attitude) of the original plate 1 is finely adjusted (corrected) by the correction mechanism 9 based on the calculated average position correction value, and performing pattern transferring (nanoimprinting) by pressing the original plate 1 down on the areas of the substrate in sequence wherein the areas correspond to chip 41, chip 42, chip 43, . . . , thereby the overhead time can be reduced.

In the case of the global alignment method as well, the misalignment inspection is performed. By performing the alignment inspection to the chip 41 which is subjected to the first pattern transferring, the results of the alignment inspection can be fed back to the subsequent pattern transferring position.

In addition, for example, as shown in FIG. 51 in a case where the pattern transferred position is shifted by ΔL as the result of misalignment inspection after the all patterns transferring on the same layer, and the alignment error exceeds acceptable value, a pattern transferring onto an upper layer is stopped, the wafer is unloaded, the light curing resin is removed, and the rework may be performed by feeding back the result of the misalignment inspection. In the rework, if the pattern transferring is performed by inputting the correction value (ΔL) to a controller not shown in advance, the alignment error can be within the acceptable value.

In the present embodiment, the microfabrication apparatus and microfabrication method that the pattern transferring is performed by contacting the original plate and the object substrate by using the light curing system pressing type microfabrication apparatus are explained. However, in a case where an apparatus other than the light curing system pressing type microfabrication apparatus, for example, a heat curing system pressing type microfabrication apparatus may be used. Even in the case, by using a similar configuration of apparatus, the lowering of throughput of device manufacturing using nanoimprint technique is suppressed.

As described above, the present embodiment can make misalignment inspection between the underlying pattern of the object substrate and the transfer pattern on the underlying pattern in the microfabrication apparatus, thus allowing lowering of throughput of device manufacturing using nanoimprint technique to be suppressed. In addition, it is possible to transfer the fine pattern with higher position accuracy by correcting positions of subsequent transferred patterns using the detected misalignment amount.

### Second Embodiment

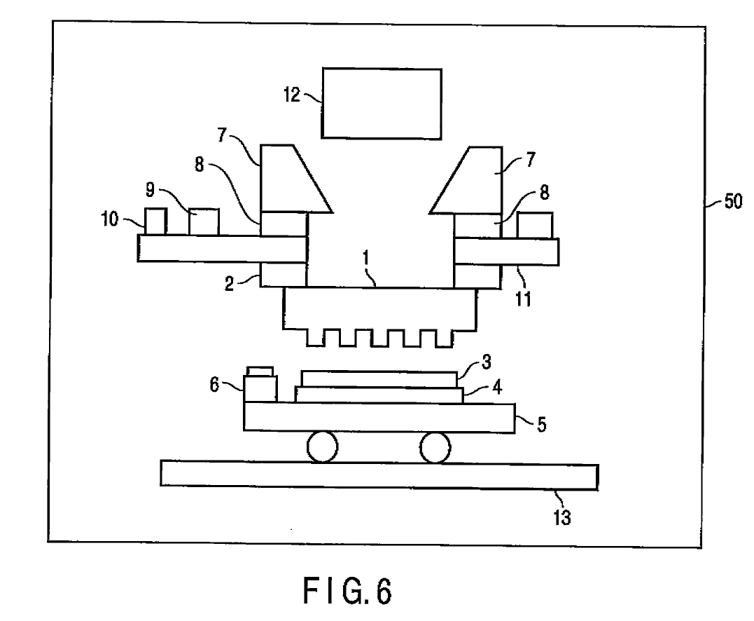

FIG. 6 schematically shows a microfabrication apparatus of a second embodiment. In FIG. 6, corresponding parts to those in FIG. 1 are denoted by like reference numerals and detailed descriptions thereof are omitted.

The second embodiment differs from the first embodiment in that no dedicated misalignment inspection mechanism is installed and the alignment sensors 7 serve as the misalignment inspection mechanism.

In the present embodiment, a misalignment inspection is carried out in step S7 of the flowchart shown in FIG. 2. For this reason, the sample stage 5 is moved such that the alignment inspection mark comes directly under the optical axis of the alignment sensor 7.

As the plurality of alignment sensors 7 are installed, the misalignment inspection is made by using one of the plurality of alignment sensors 7, or using at least two of the plurality of alignment sensors 7. In the latter case, the alignment inspection marks corresponding in number to the alignment sensors 7 are formed. The misalignment inspection is made for a preset number of marks to calculate and analyze alignment errors.

According to the present embodiment, as the alignment sensors 7 is also used for misalignment inspection, the misalignment inspection between the original plate 1 and the object substrate 3 is performed easily in the microfabrication apparatus, thereby the throughput of device the manufacturing using nanoimprint technique is further improved. In addition, as in the first embodiment, it is possible to transfer the fine pattern with higher position accuracy by correcting positions of subsequent transferred patterns using the detected misalignment amount. Furthermore, using the alignment sensors 7 for misalignment inspection allows the apparatus cost to be reduced. Fine patterns can be transferred with higher position accuracy without addition of great modifications to an existing apparatus.

### Third Embodiment

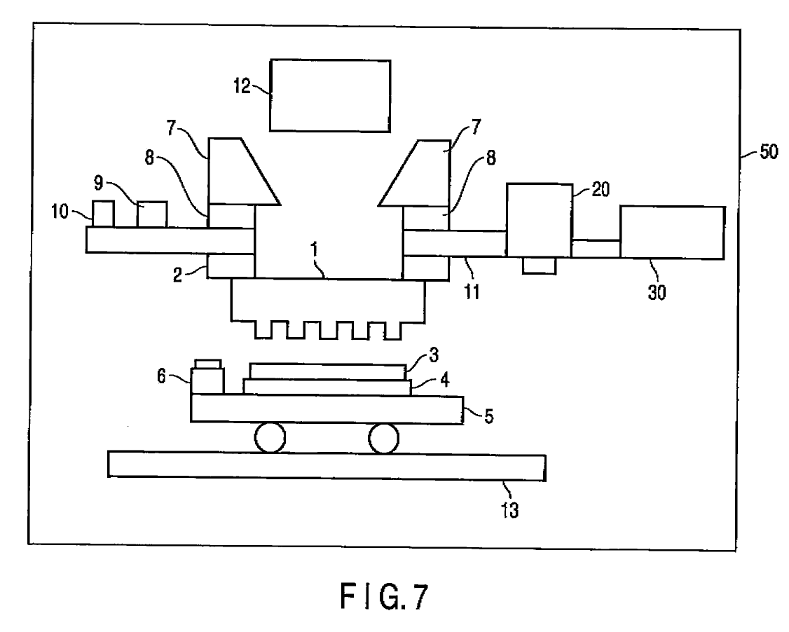

FIG. 7 schematically shows a microfabrication apparatus of a third embodiment. In FIG. 7, corresponding parts to those in FIG. 1 are denoted by like reference numerals and detailed descriptions thereof are omitted.

The second embodiment differs from the first embodiment in that decision whether the semiconductor chip formed in the transfer substrate (wafer) is acceptable or rejectable is performed. Thus, the microfabrication apparatus of the present embodiment further comprises a chip quality decision unit 30 (decision unit) for deciding whether the semiconductor chips is acceptable or rejectable based on the result of inspection made in step S7 of FIG. 2 (misalignment amount of transferred pattern).

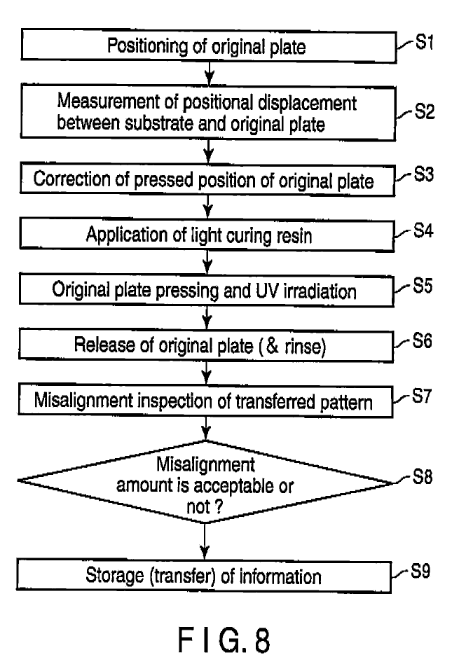

FIG. 8 is a flowchart illustrating a fine patterning method of the third embodiment.

Processing steps S1 through S7 are carried out as in the case of the first embodiment.

[Step S8]

On the basis of an alignment error of a transferred pattern obtained in step S7, the chip including the transferred pattern is determined whether it is acceptable or rejectable. For example, the chip quality is determined by comparing the misalignment amount of the transferred pattern with a predetermined alignment inspection reference value. Specifically, the decision is made as to whether or not the misalignment amount of the transferred pattern falls within a predetermined allowable range. This decision is made for each of the chips formed in the substrate (wafer).

[step S9]

The results of the quality determinations made in step S8 (i.e., which chips are rejectable (NG chips)) are held in a control system (not shown) in the microfabrication apparatus. The results of inspection in step S7 (misalignment amount of transferred patterns) are also stored in that control system. The information (NG chips and misalignment amount of transferred patterns) stored in the control system is transferred to a product information control system (CIM: computer-integrated manufacturing system) and utilized in subsequent semiconductor manufacturing processes. For example, relating to the chips determined to be rejectable, it is possible to omit pattern transfer processes or draw dummy patterns in subsequent fine patterning processes. By so doing, throughput can be improved.

### Fourth Embodiment

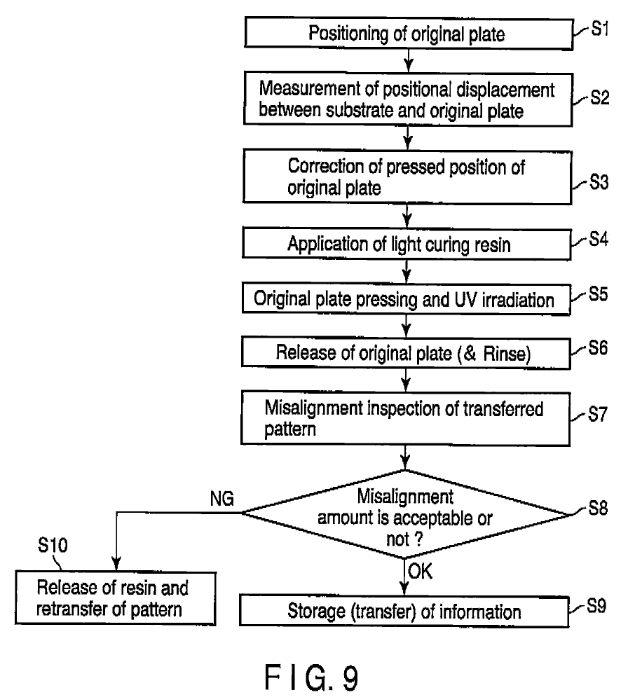

FIG. 9 is a flowchart illustrating a fine patterning method of a fourth embodiment.

The fourth embodiment differs from the third embodiment in that, relating to the chips decided rejectable, the photosensitive resin (resist pattern) is peeled off and pattern transfer is made again. For example, this can be performed by transferring the result of decision in step S8 to the product information control system and sending from the product information control system to the control system of the microfabrication apparatus an instruction to peel off the photosensitive resin and an instruction to make pattern transfer again.

### Fifth Embodiment

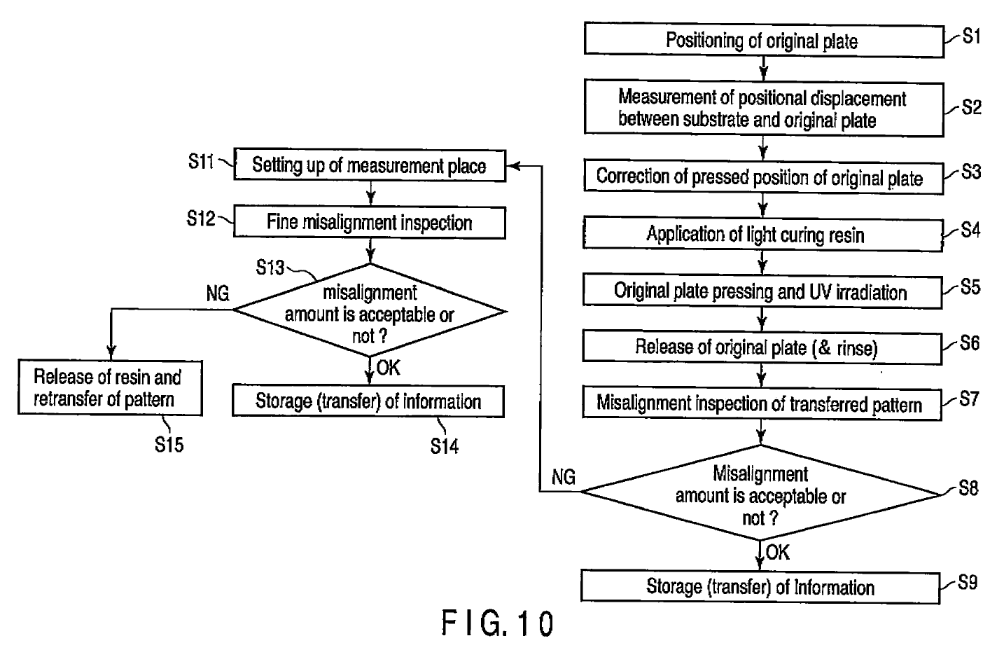

FIG. 10 is a flowchart illustrating a fine patterning method of a fifth embodiment.

The fifth embodiment differs from the third embodiment in that the chips decided rejectable in step S8 are subjected to reinspection.

[Step S11]

When the decision in step S8 is NG, measurement places (measurement positions, the number of points to be measured) are set up again. At this time, the measurement places are set up so that inspection is made more finely (closely) than in step S7.

[Step S12]

The alignment inspection is made finely (closely) according to the measurement places set up again.

[Step S13]

As in the case of step S8, the chip including the transferred pattern is decided whether it is acceptable or rejectable based on the misalignment amount of the transferred pattern obtained in step S12.

### [Step S14]

The results of decision in step S13, that is, the chips decided acceptable (OK chips), are stored in the control system. The information stored in the control system is transferred to the product information control system for utilization in the subsequent semiconductor manufacturing process.

[Step S15]

On the other hand, as to the chips decided NG in step S13, the photosensitive resin (resist pattern) is peeled off and the pattern transfer is made again.

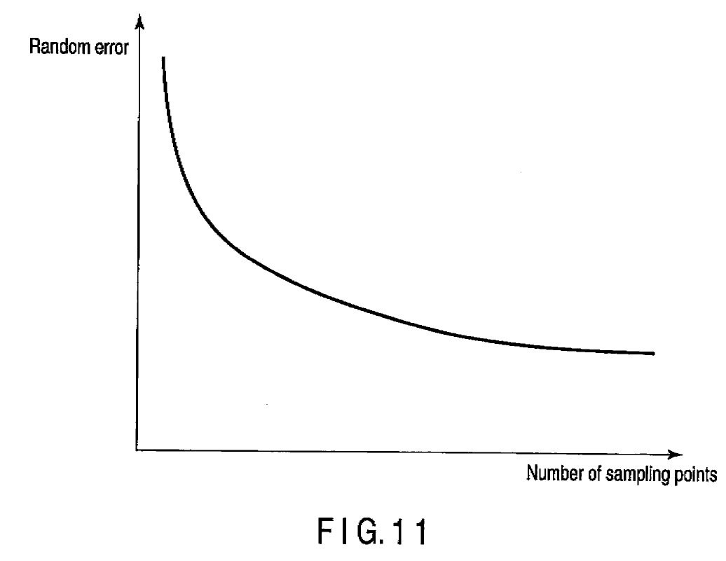

The alignment inspection of the present embodiment is based on the property of the number of sampling points as shown in FIG. 11. That is, using the property that the random error is offset by increasing the number of sampling points and decreases on a statistical basis, the results of misalignment inspection can be determined on the basis of a preset number of sampling points and a misalignment tolerance for the sampling points.

Another way to utilize the alignment inspection information in the method shown in FIG. 10 is to set misalignment inspection for all chips to be made in step S12 in setting up the measurement places again in step S11 when the decision in step S8 is NG.

In this case, a map of NG chips is created using the results of inspection of all chips in step S13 and transferred to the product information control system, thereby managing and utilizing the NG chip information in subsequent manufacturing processes.

Thereby, for example, even if some NG chips exists, continuation of the manufacturing the semiconductor devices allows the turn around time (TAT) to be improved, the optimum manufacturing method can be adopted which takes into consideration priority items for each product in the manufacturing semiconductor devices.

In addition, in a case where that the products have TAT priority and require the small number of chips acquisition when only the chips on the outside of the wafer are rejectable (NG) due to some causes, it is only required to carry out information management so as to get only chips on the inside of the wafer as products instead of peeling off the photosensitive resin and transferring the pattern again.

### Sixth Embodiment

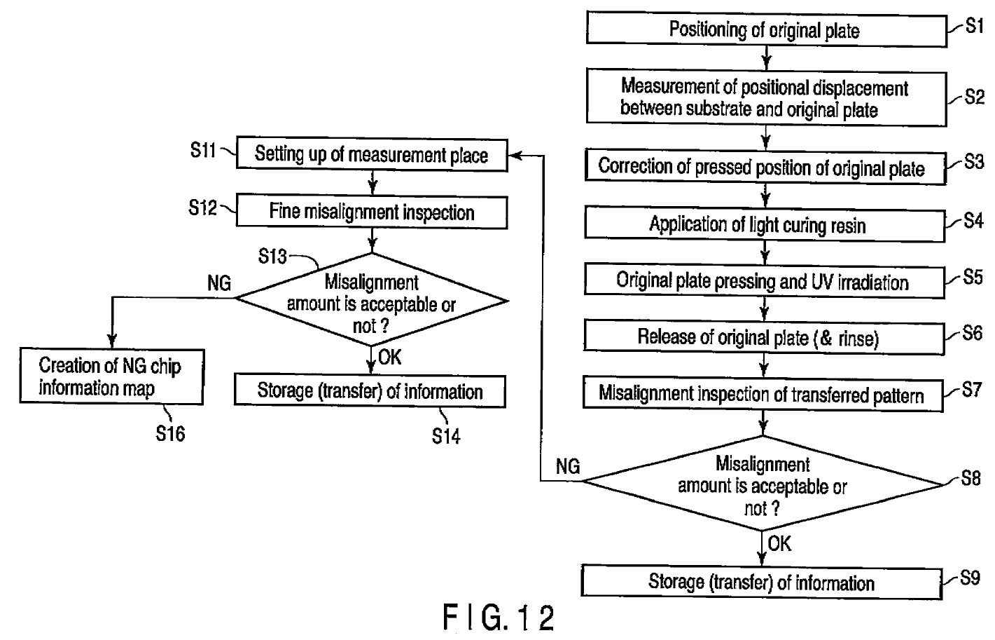

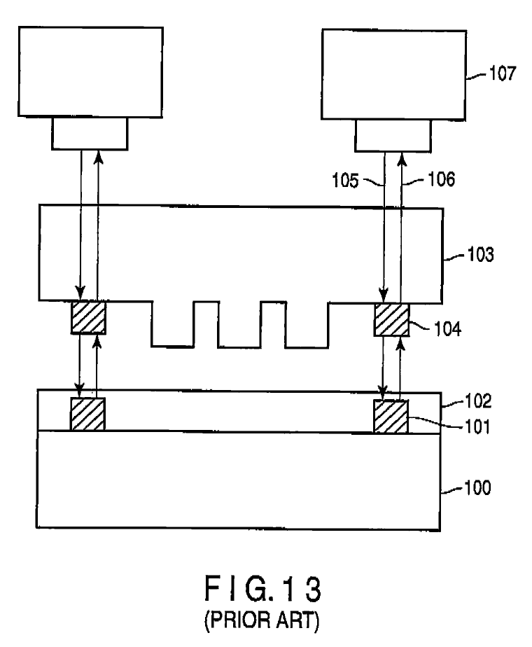

FIG. 12 is a flowchart illustrating a fine patterning method of a sixth embodiment.

The sixth embodiment differs from the fourth embodiment in that, when the decision in step S13 is NG, information (NG chip information map) is created which can be utilized as information at the drawing time of the upper layer (step S16).

The NC chip information map is transferred to the product information control system together with the results of misalignment inspection. Thereby, restrictions can imposed on parameter settings of exposure recipe using the NG chip information map in the prior transfer process so that alignment marks belonging to the chips decided NG in misalignment inspection are not used. Thereby, it becomes possible to avoid in advance the risk that the results of misalignment inspection become NG, allowing the risk of lowering TAT due to the release and retransfer (rework) to be reduced.

Subjects of the microfabrication apparatuses and methods of the above mentioned embodiments include semiconductor device such as MOS transistor constituting CMOS logic, optical device such as microlens array, and device formed on an Si wafer that form bio-products such as DNA chips.

A device manufacturing method of the embodiments includes pressing an original plate including a pattern down on the object substrate to transfer the pattern on the object substrate and etching the object substrate using the transferred pattern as a mask. This allows the manufacture of semiconductor device such as MOS transistors constituting CMOS logic, optical devices such as microlens arrays, and devices formed on an Si wafer that form bio-products such as DNA chips.

In addition, the misalignment inspection by the misalignment inspection mechanism (second measuring unit) may be performed outside the chamber of the microfabrication apparatus, and the results of the inspection may be fed back to the original plate pressing process.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A microfabrication apparatus configured to press an original plate including a pattern down on an object substrate to transfer the pattern on the object substrate, the microfabrication apparatus comprising:
a first measurement unit configured to measure relative positional displacement between the object substrate and the original plate disposed above the object substrate;
a position correction unit configured to correct relative position between the object substrate and the original plate such that the pattern is to be transfer on a first predetermined position of the object substrate based on the relative positional displacement measured by the first measurement unit;
a pressing unit configured to press the original plate disposed above the object substrate down on the object substrate to transfer the pattern on the object substrate in a state that the relative positional displacement between the object substrate and the original plate is corrected by the position correction unit; and
a second measurement unit configured to measure relative positional relationship between the pattern transferred on the object substrate and a pattern previously formed on the object substrate.

2. The microfabrication apparatus according to claim 1, when the pattern is further transferred on a second predetermined position of the object substrate wherein the second predetermined position is on a layer same as that of the first predetermined position, the position correction unit corrects the relative position between the original plate and the object substrate such that the pattern is to be transferred on the second predetermined position based on the positional relationship measured by the second measurement unit.

3. The microfabrication apparatus according to claim 1, when a pattern is transferred on a third predetermined position of the object substrate wherein the pattern is on a higher layer than that of previously transferred pattern, the position correction unit corrects the relative position between the original plate and the object substrate such that the pattern on the higher layer is to be transferred on the third predetermined position based on the positional relationship measured by the second measurement unit.

4. The microfabrication apparatus according to claim 1, further comprising a decision unit configured to decide whether a chip in the object substrate is acceptable or rejectable wherein the chip includes the transferred pattern, and a holding unit configured to hold information of the chip in a case where the chip is decided rejectable by the decision unit.

5. The microfabrication apparatus according to claim 2, further comprising a decision unit configured to decide whether a chip in the object substrate is acceptable or rejectable wherein the chip includes the transferred pattern, and a holding unit configured to hold information of the chip in a case where the chip is decided rejectable by the decision unit.

6. The microfabrication apparatus according to claim 3, further comprising a decision unit configured to decide whether a chip in the object substrate is acceptable or rejectable wherein the chip includes the transferred pattern, and a holding unit configured to hold information of the chip in a case where the chip is decided rejectable by the decision unit.

7. The microfabrication apparatus according to claim 1, wherein the first measurement unit is an alignment sensor, the second measurement unit is an overlay inspection apparatus.

8. The microfabrication apparatus according to claim 2, wherein the first measurement unit is an alignment sensor, the second measurement unit is an overlay inspection apparatus.

9. The microfabrication apparatus according to claim 3, wherein the first measurement unit is an alignment sensor, the second measurement unit is an overlay inspection apparatus.

10. The microfabrication apparatus according to claim 1, wherein the first measurement unit serves as the second measurement unit.

11. The microfabrication apparatus according to claim 2, wherein the first measurement unit serves as the second measurement unit.

12. The microfabrication apparatus according to claim 3, wherein the first measurement unit serves as the second measurement unit.

13. A device manufacturing method comprising:
pressing an original plate including a pattern down on an object substrate to imprint the pattern on the object substrate by using a microfabrication apparatus configured to press the original plate down on the object substrate to imprint the pattern on the object substrate; and
etching the object substrate by using the imprinted pattern as a mask,
wherein the microfabrication apparatus comprising:
a first measurement unit configured to measure relative positional displacement between the object substrate and the original plate disposed above the object substrate;
a position correction unit configured to correct relative position between the object substrate and the original plate such that the pattern is to be imprinted on a first predetermined position of the object substrate based on the relative positional displacement measured by the first measurement unit;
a pressing unit configured to press the original plate disposed above the object substrate down on the object substrate to imprint the pattern on the object substrate in a state that the relative positional displacement between the object substrate and the original plate is corrected by the measurement unit; and
a second measurement unit configured to measure relative positional relationship between the pattern imprinted on the object substrate and a pattern previously formed on the object substrate.

14. The device manufacturing method according to claim 13, when the pattern is further transferred on a second predetermined position of the object substrate wherein the second predetermined position is on a layer same as that of the first predetermined position, the position correction unit corrects the relative position between the original plate and the object substrate such that the pattern is to be transferred on the second predetermined position based on the positional relationship measured by the second measurement unit.

15. The device manufacturing method according to claim 13, when a pattern is transferred on a third predetermined position of the object substrate wherein the pattern is on a higher layer than that of previously transferred pattern, the position correction unit corrects the relative position between the original plate and the object substrate such that the pattern on the higher layer is to be transferred on the third predetermined position based on the positional relationship measured by the second measurement unit.

16. The device manufacturing method according to claim 13, further comprising a decision unit configured to decide whether a chip including the imprinted in the object substrate is acceptable or rejectable, and a holding unit configured to hold information of the chip in a case where the chip is decided rejectable by the decision unit.

17. The device manufacturing method according to claim 13, wherein the first measurement unit is an alignment sensor, the second measurement unit is an overlay inspection apparatus.

18. The device manufacturing method according to claim 13, wherein the first measurement unit serves as the second measurement unit.
